(19) United States
(12) Patent Application Publication
(10) Pub. No.: US 2015/0221221 A1
(43) Pub. Date: Aug. 6, 2015

(54) WIRELESS TRAFFIC CONGESTION AND HAZARDOUS CONDITION DETECTION AND WARNING SYSTEM

(71) Applicants: Brett Houston Schaefer, Fayetteville, AR (US); Andrew McCall Dodson, Richburg, SC (US); Scott Christopher Smith, Moorhead, MN (US); Christopher Patrick Farnell, Fayetteville, AR (US); Brett Edward Sparkman, Fayetteville, AR (US)

(72) Inventors: Brett Houston Schaefer, Fayetteville, AR (US); Andrew McCall Dodson, Richburg, SC (US); Scott Christopher Smith, Moorhead, MN (US); Christopher Patrick Farnell, Fayetteville, AR (US); Brett Edward Sparkman, Fayetteville, AR (US)

(73) Assignee: VISUALOGISTIC TECHNOLOGIES, INC., Fayetteville, AR (US)

(21) Appl. No.: 14/170,803

(22) Filed: Feb. 3, 2014

(51) Int. Cl. G08G 1/0967

(52) U.S. Cl. CPC G08G 1/0967

(57) ABSTRACT

A Wireless Traffic Congestion and Hazardous Condition Detection and Warning System. The system utilizes electronic nodes placed alongside a highway to detect traffic congestion and other hazardous conditions, visually notify drivers of a detected hazardous condition, and wirelessly communicate the hazardous condition to neighboring nodes in order to notify drivers well in advance of the hazard. A detected hazardous condition can also be transmitted through the existing cellular network to enable remote monitoring of traffic flow and remote notification of detected hazardous conditions.

### BACKGROUND

According to 2010 National Highway Transportation Safety Administration (NHTSA) statistics, there were 27,511 fatal crashes on our nation's highways, involving 38,472 vehicles. Driving too fast for conditions or in excess of the posted speed limit contributed to approximately 38% of these crashes, which was considerably higher than any other contributing factor. Therefore, a low-cost noninvasive system to detect traffic congestion and other hazardous driving conditions, such as approaching emergency vehicles or the potential for icing or fog, and forewarn drivers of the upcoming hazard, is needed to significantly decrease highway accidents and save lives.

### SUMMARY

The invention pertains to the fields of Transportation Safety, Computer Engineering, and Electrical Engineering. The invention consists of a plurality of electronic nodes to be placed alongside a highway, where each node has the ability to detect traffic congestion and other hazardous conditions, visually notify drivers of a detected hazardous condition, and wirelessly communicate the hazardous condition to neighboring nodes in order to notify drivers well in advance of the hazard.

In one embodiment, the invention provides a Basic Node (BN) consisting of a sensor, or plurality of sensors, that detect hazardous driving conditions. One sensor, or plurality of sensors, measures traffic flow to detect traffic speed and congestion.

In some embodiments, the BN includes a sensor, or plurality of sensors, to detect inclement weather conditions, such as the potential for road icing or fog.

In some embodiments, the BN includes a sensor, or plurality of sensors, to detect an approaching emergency vehicle.

In some embodiments, the BN includes a manual caution switch, that when activated, causes the node to display a hazardous condition, even though one may not be currently detected at that node.

In some embodiments, a BN has the ability to communicate through the existing cellular network, which allows for remote monitoring of traffic flow and remote notification of detected hazardous conditions. This type of node is referred to as a Cellular Node (CN).

In some embodiments, a BN has an additional traffic flow measuring sensor, or plurality of sensors, which enables this node to simultaneously measure traffic flow in both directions when placed in a median separating the two sides of a highway. This type of node is referred to as a Median Basic Node (MBN).

In some embodiments, a CN has an additional traffic flow measuring sensor, or plurality of sensors, which enables this node to simultaneously measure traffic flow in both directions when placed in a median separating the two sides of a highway. This type of node is referred to as a Median Cellular Node (MCN).

Detection of traffic congestion or the potential for road icing or fog would trigger visual driver notification at the detecting node and wirelessly communicating the hazard to one or more upstream nodes in order to forewarn approaching drivers well before the hazard, while detection of an approaching emergency vehicle would trigger visual driver notification at the detecting node and wirelessly communicating the hazard to one or more downstream nodes in order to forewarn drivers that an emergency vehicle is approaching them from behind.

Each node consists of one or more sensors and other peripherals that detect hazardous driving conditions, visually display a detected hazardous condition to notify drivers, and wirelessly communicate a detected hazardous condition to neighboring nodes, a device(s) to enter the node's GPS coordinates and/or a user programmable address used to determine the addresses of neighboring nodes to receive each communiqué, a manual caution switch, and a microcontroller to read the sensor and other input(s), process the sensor data to determine if a hazardous condition is being detected, interface with the visual display to show when a hazardous condition has been detected or the manual caution switch has been activated, and interface with a wireless transceiver to transmit and receive hazardous condition notifications to/from neighboring nodes. Each node also contains a device to harvest energy from its surrounding environment, a rechargeable battery, and DC-DC power converters as necessary, to provide the specified supply voltage level to each node component. In addition to these components, a CN and MCN also include a GSM module to enable the node to communicate through the existing cellular network.

The node sensors are low-cost and noninvasive, including but not limited to a sonar or laser proximity detector, Lidar, and/or radar, used to calculate traffic congestion and speed, atmospheric temperature and humidity sensors used to determine inclement weather conditions, and a sensor(s) to detect a transmitted beacon signal from a nearby emergency vehicle. Choices for the visual display include, but are not limited to, a multi-colored LED. Choices for the user programmable address include, but are not limited to, a plurality of DIP switches or a keypad. Choices for the energy harvesting device include, but are not limited to, a solar cell.

In another embodiment, the invention provides a wireless sensor network (WSN) consisting of a plurality of nodes, comprised of zero, one, or a plurality of, BNs, CNs, MBNs, and MCNs, in any combination. Any node in this WSN can wirelessly communicate with any other node in the network, either directly, or through the use of one, or a plurality of, other nodes in the network. Failure of a single node will not break the communication ability between its upstream and downstream nodes. If the WSN includes one, or a plurality of, CNs or MCNs, it can perform a self test on a routine basis to identify and remotely report failed nodes.

Other aspects of the invention will become apparent by consideration of the detailed description and accompanying drawings.

### BRIEF DESCRIPTION OF THE DRAWINGS

FIG. 1 is a block diagram of a segment of the overall system.

FIG. 2 is an example of detection of heavy traffic congestion.

FIG. 3 is an example of detection of an approaching emergency vehicle (EV).

FIG. 4 is an example of how node addresses need not be unique.

FIG. 5 is a block diagram of a Basic Node (BN).

FIG. 6 is a block diagram of .a Cellular Node (CN).

FIG. 7 is a block diagram of a Median Basic Node (MBN).

FIG. 8 is a block diagram of a Median Cellular Node (MCN).

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. The specific LED indicator colors described in the examples below do not prohibit the use of other color representations for alternative embodiments.

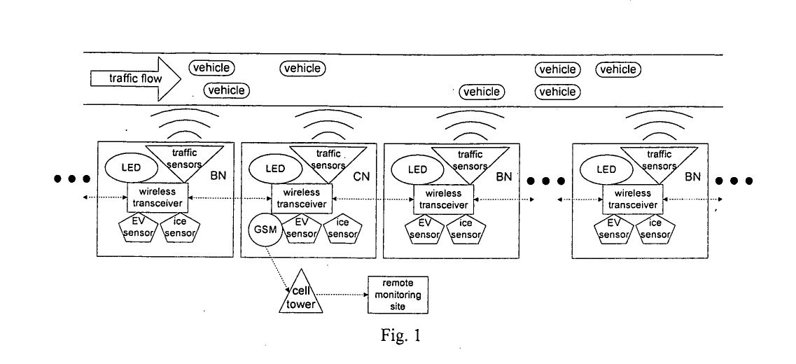

FIG. 1 depicts a block diagram of a segment of the overall system, consisting of multiple Basic Nodes (BNs) and a Cellular Node (CN) placed alongside a highway, where each node has sensors to detect traffic congestion and speed, conditions conducive to road icing, and nearby emergency vehicles (EVs), a multi-colored LED to visually notify drivers of a detected hazardous condition, and a wireless transceiver to communicate a detected hazardous condition to neighboring nodes in order to notify drivers well in advance of the hazard. In addition to these components, the CN also includes a GSM component used to communicate through the existing cellular network to enable traffic flow to be remotely monitored and notification of detected hazardous conditions to be transmitted to a remote location(s).

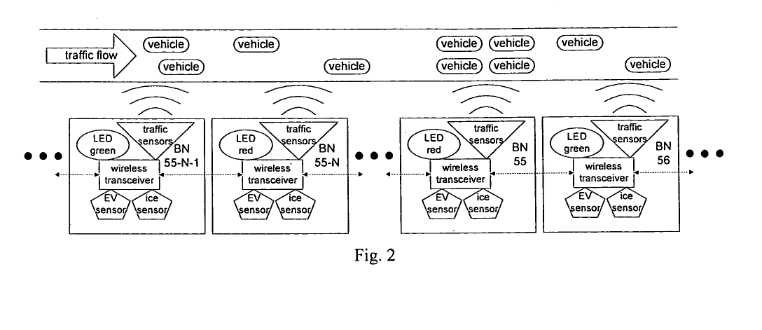

As depicted in FIG. 2, detection of heavy traffic congestion by BN55 turns its LED red and wirelessly transmits this condition to a preprogrammed number, N, of upstream nodes to turn their LEDs red to signal drivers of the congestion ahead. Detection of moderate traffic congestion by a node prompts the same response as heavy traffic congestion detection except the driver notification LEDs are turned yellow instead of red. A green LED indicates no hazardous traffic conditions present.

Detection of conditions conducive to icing or fog by a node would turn its LED orange and wirelessly transmit this condition to a preprogrammed number, M, of upstream nodes to turn their LEDs orange to signal drivers to be cautious of possible adverse road conditions ahead.

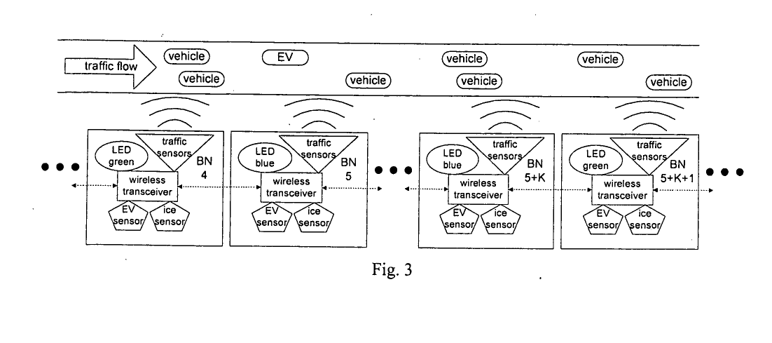

As depicted in FIG. 3, detection of an approaching emergency vehicle (EV) by BN5 turns its LED blue and wirelessly transmits this condition to a preprogrammed number, K, of downstream nodes to turn their LEDs blue to signal drivers that an emergency vehicle is approaching them from behind.

A node may also be equipped with a manual caution switch, that when activated, causes the node to display a hazardous condition, even though one may not be currently detected at that node. For example, nodes approaching a construction zone may be manually switched to display moderate traffic congestion, indicated by a yellow LED, to forewarn drivers to slowdown, even when traffic through the construction zone is not congested enough to itself trigger the LEDs to switch from green to yellow. Note that in this case, if heavy traffic congestion in the construction zone was detected, the LEDs would turn from yellow to red, since heavy traffic congestion would have a higher priority over the manual caution switch. Also note that the hazardous condition display caused by activation of a manual caution switch may or may not be proliferated to N number of upstream nodes, depending on how the system is programmed.

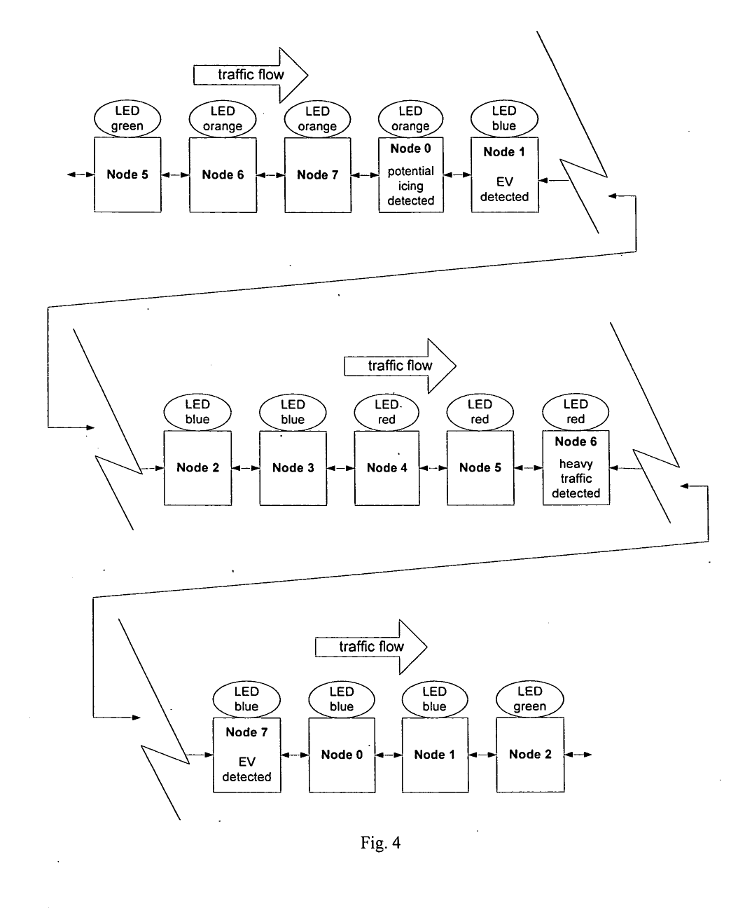

Each node's address is programmed during node installation (e.g., by setting DIP switches or entering the address using a keypad); and the address of its immediate upstream node is programmed to be 1 less, and its immediate downstream node to be 1 more. Hence, an offset can be calculated by a detecting node to determine which neighboring nodes should be sent the hazard detection communiqué. Each node in the overall system does not need a unique address, as long as there are enough unique addresses to identify the neighbors of each node that need to receive each type of hazard detection communiqué. For example, if any type of hazard was to be sent to two neighboring nodes, then a 3-bit address (i.e., 8 unique addresses) would be sufficient. In this example, depicted in FIG. 4, heavy traffic congestion detected at node 6 would be sent to nodes 5 and 4, while an emergency vehicle detected at node 1 would be sent to nodes 2 and 3. The addresses repeat, such that the total number of nodes is unlimited. Hence, potential icing detected at node 0 would be sent to upstream nodes 7 and 6, while an emergency vehicle detected at node 7 would be sent to downstream nodes 0 and 1. During installation, the node's GPS coordinates can also be programmed and stored internal to the device to be used for unique device identification for remote traffic monitoring and remote notification.

If the system includes remote monitoring and notification, then a detected hazard communiqué would be transmitted until a CN receives the transmission, which in turn would utilize its GSM module to remotely transmit the detected hazard. This could be achieved by transmitting the communiqué from the detecting node to the nearest CN in the direction the communiqué is to be sent (i.e., upstream for traffic congestion or inclement weather conditions, and downstream for an emergency vehicle). This could also be achieved by transmitting the communiqué from the detecting node to the nearest CN regardless of the direction the communiqué is to be sent. Alternate methods to transmit a detected hazard communiqué to a CN are also possible.

The segment of the overall system depicted in FIG. 1 would be replicated as many times as desired to form the complete system for a single side of the highway, monitoring traffic in one direction. This complete system for one side of the highway would then be replicated on the other side to form the overall system to monitor traffic in both directions.

This overall system forms one or more wireless sensor network(s), where each node wirelessly communicates with other nodes in the network. Note that a single node failure will not break the communication ability between its upstream and downstream nodes; these two nodes will still be able to communicate with each other despite the failure of the node between them. However, if a number of adjacent nodes fail, then communication between their upstream and downstream nodes may be broken if the distance between working nodes exceeds the distance of their wireless communication transceivers.

The nodes on each side of the highway could form their own wireless sensor network, or the nodes on both sides could form a single wireless sensor network. This second option is more robust, but requires additional complexity.

If the system includes one or more CNs, then the system could perform a self test on a routine basis to identify and remotely report failed nodes, so that they could be fixed or replaced before enough nodes fail to cause communication failure between working nodes in the wireless sensor network.

For highways with a narrow median divider, a node could be placed in the median to detect traffic congestion in both directions. This node, referred to as a Median Node (MN), could be either a BN or CN with an additional traffic flow measuring sensor, or plurality of sensors, referred to as a MBN or MCN, respectively. A MN would be used in lieu of two nodes, one on each side of the highway, thereby decreasing hardware cost for the system at the expense of increased complexity.

If a node is to simultaneously display multiple detected hazardous conditions, it could either only display the highest priority hazardous condition, or alternate the LED color to notify drivers of all of the different types of detected hazardous conditions. LED intensity can be varied depending on ambient light to provide an easily visible indicator for drivers in all light conditions. The invention is not limited to the LED colors used in the embodiment described above, or using an LED for the visual display.

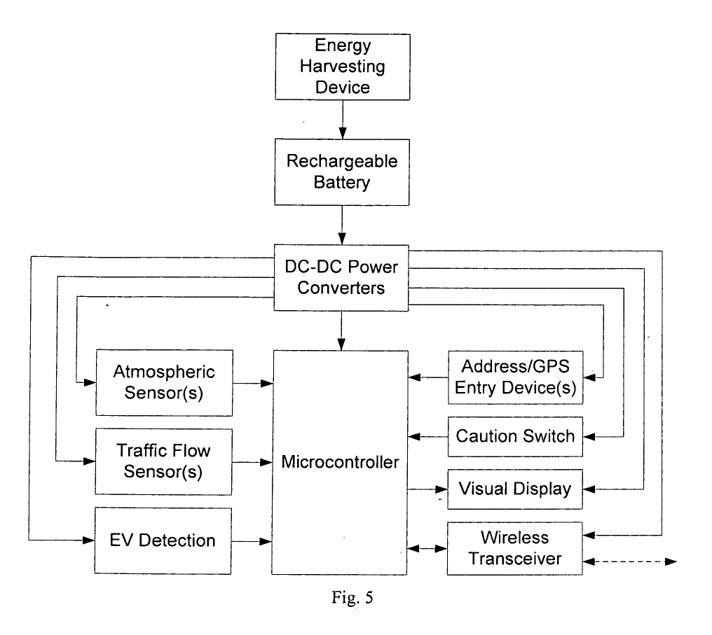

Referring to FIG. 5, a Basic Node (BN) consists of a sensor(s) for measuring traffic flow, an atmospheric sensor(s) for detecting conditions conducive to inclement weather, a sensor(s) for detecting an approaching emergency vehicle (EV), a visual display to notify drivers of a detected hazardous condition, a device(s) for programming the node's address and/or GPS coordinates, a wireless transceiver to communicate with neighboring nodes, and a manual caution switch, each coupled to a microcontroller that reads the sensor and other inputs, processes the sensor data to determine if a hazardous condition is being detected, interfaces with the visual display to show when a hazardous condition has been detected, and interfaces with the wireless transceiver to transmit and receive hazardous condition notifications to/from neighboring nodes. A BN also contains a device to harvest energy from its surrounding environment, coupled to a rechargeable battery, which is coupled to DC-DC power converters, as necessary, to provide the specified supply voltage level to each component.

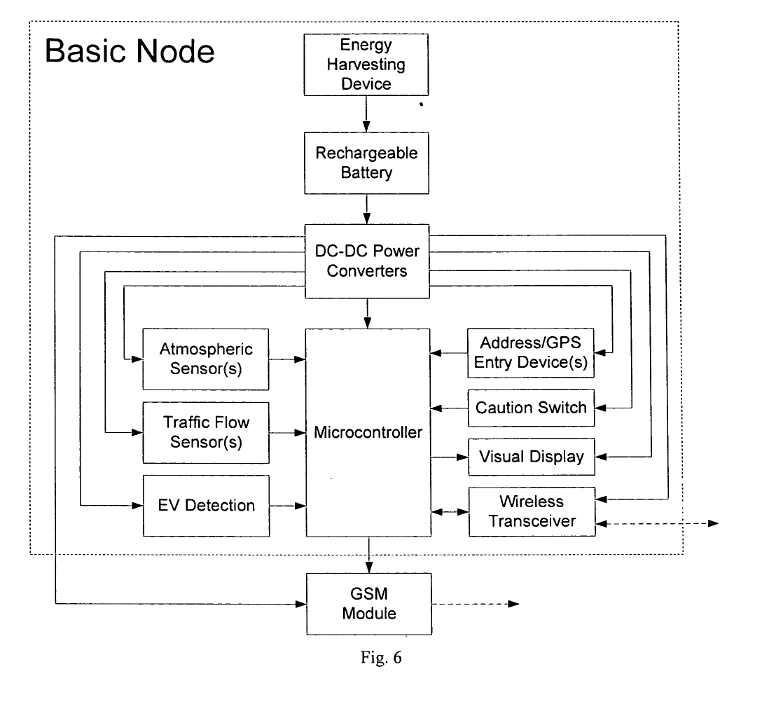

Referring to FIG. 6, a Cellular Node (CN) consists of a BN with an additional GSM module coupled to the microprocessor to enable communication through the existing cellular network, which will allow for remote monitoring of traffic flow and remote notification of detected hazardous conditions.

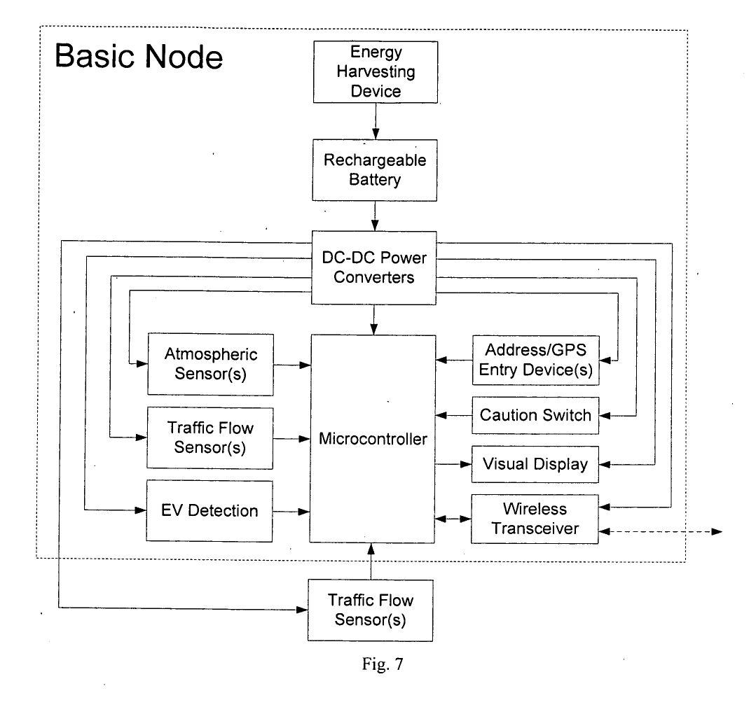

Referring to FIG. 7, a Median Basic Node (MBN) consists of a BN with an additional traffic flow sensor(s) coupled to the microprocessor to enable this node to simultaneously measure traffic flow in both directions when placed in a median separating the two sides of a highway.

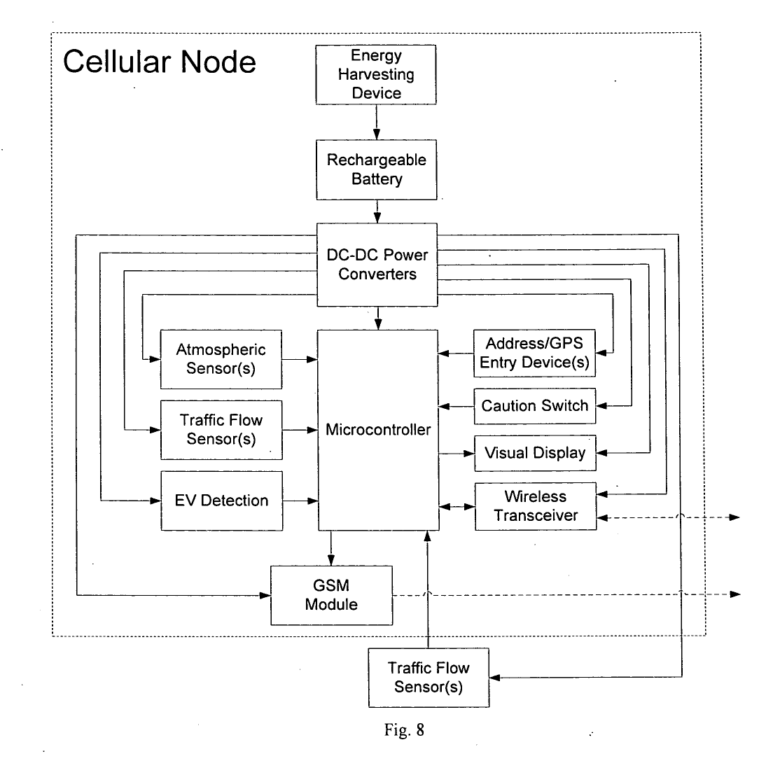

Referring to FIG. 8, a Median Cellular Node (MCN) consists of a CN with an additional traffic flow sensor(s) coupled to the microprocessor to enable this node to simultaneously measure traffic flow in both directions when placed in a median separating the two sides of a highway.

What is claimed is:

1. A Basic Node (BN), the BN comprising:
a sensor, or plurality of sensors, and other peripherals, that detect hazardous driving conditions, including one sensor, or plurality of sensors, that measure traffic flow to detect traffic speed and congestion, a display to visually notify drivers of a detected hazardous condition, and a peripheral to wirelessly communicate a hazardous condition to neighboring nodes in order to notify drivers well in advance of the hazard, all integrated into a self-contained unit, which does not require connection to the power grid and does not require wired connection for communication with neighboring nodes.

2. The system of claim 1, wherein a sensor, or plurality of sensors, detect conditions conducive to road icing and/or fog.

3. The system of claim 1, wherein a sensor, or plurality of sensors, detects an approaching emergency vehicle.

4. The system of claim 1, wherein a peripheral is a manual caution switch, that when activated, causes the node to display a hazardous condition, even though one may not be currently detected at that node.

5. The system of claim 1, wherein one or more peripherals are utilized for programming the node's address and/or GPS coordinates during installation.

6. The system of claim 1, comprising:
a microcontroller;
a sensor, or plurality of sensors, coupled to the microcontroller;
a visual display, coupled to the microcontroller;
a wireless transceiver, coupled to the microcontroller;
a device(s) to enter the node's address and GPS coordinates, coupled to the microcontroller;
an energy harvesting device;
a rechargeable battery coupled to the energy harvesting device; and
one, or a plurality of, DC-DC converters coupled to the rechargeable battery and the microcontroller, sensors, visual display, wireless transceiver, address and GPS entry device(s), and other peripherals.

7. The system of claim 1, wherein the sensor(s) include a sonar or laser proximity detector, Lidar, and/or radar, to measure traffic flow to detect traffic speed and congestion.

8. The system of claim 1, wherein a multi-colored LED, whose intensity can be varied depending on ambient light, is utilized for the visual display.

9. The system of claim 1, wherein a solar sell is utilized as its energy harvesting device.

10. The system of claim 1, wherein a peripheral communicates detected hazardous conditions to a remote location using the existing cellular network, which is referred to as a Cellular Node (CN).

11. The system of claim 10, wherein a GSM module coupled to the microcontroller and to the DC-DC converter(s) communicates detected hazardous conditions to a remote location using the existing cellular network.

12. The system of claim 1, wherein a sensor, or plurality of sensors, measure traffic flow to enable speed and congestion to be simultaneously detected in traffic travelling in opposite directions, which is referred to as a Median Basic Node (MBN).

13. The system of claim 12, wherein a peripheral communicates detected hazardous conditions to a remote location using the existing cellular network, which is referred to as a Median Cellular Node (MCN).

14. The system of claim 13, wherein a GSM module coupled to the microcontroller and to the DC-DC converter(s) communicates detected hazardous conditions to a remote location using the existing cellular network.

15. A wireless sensor network (WSN), the WSN comprising:
a plurality of nodes, consisting of any combination of BNs, CNs, MBNs, and/or MCNs, placed alongside a highway, which have the ability to wirelessly communicate detected hazardous conditions with each other.

16. The system of claim 15, wherein any node in the WSN can wirelessly communicate detected hazardous conditions with any other node in the WSN, either directly, or through the use of one, or a plurality of, other nodes in the WSN.

17. The system of claim 15, wherein failure of a single node will not break the communication ability between the other nodes.

18. The system of claim 15, wherein the WSN transmits detected hazardous conditions remotely through the existing cellular network.

19. The system of claim 15, wherein the WSN performs a self test on a routine basis to identify and remotely report failed nodes.
